(19) United States
(12) Patent Application Publication
(10) Pub. No.: US 2004/0159614 A1
(43) Pub. Date: Aug. 19, 2004

(54) Method and apparatus for cleaning a water area

(76) Inventor: Antti Happonen, Kerava (FI)

Correspondence Address: BIRCH STEWART KOLASCH & BIRCH, PO BOX 747, FALLS CHURCH, VA, 22040-0747, US

(21) Appl. No.: 10/484,905

(22) PCT Filed: Jul. 17, 2002
(86) PCT No.: PCT/FI02/00639

(30) Foreign Application Priority Data
Jul. 27, 2001 (FI) 20011581

(51) Int. Cl. B01D 21/00

(52) U.S. Cl. 210/747; 210/170; 210/532.1

(57) ABSTRACT

Method and apparatus for cleaning a water area, such as a lake, pond, river or a similar water basin, wherein the water basin is provided with a suction pipe system (4) arranged in connection with the lake (1), pond or equivalent and connected to a dredging apparatus working under water, by means of which the sludge or similar waste produced or at least part of it is passed into a suction pipe (4) and through it further into a sedimentation basin (8), where the flow is retarded so that, as it advances through the basin, extra humus and sludge material is separated from it via sedimentation, and that the water thus purified is passed back into the water area, e.g. into an inflow ditch.

The present invention relates to a method as defined in the preamble of claim 1 for cleaning a water area, such as a lake, pond, river or a similar water basin. The invention also concerns an apparatus for cleaning a water area, such as a lake, pond, river or a similar water basin.

At present, dredging and cleaning of water basins are carried out using conventional machinery in which the drive engines are usually petrol-fuelled internal combustion engines. However, internal combustion engines consume fuel and pollute the air as well as water basins. Moreover, such engines are relatively noisy.

The object of the present invention is to eliminate the drawbacks of prior art and to achieve a completely new type of system for creating dredging and cleaning equipment and equivalent for use in water basins.

In the system of the invention, the sludge and other residuals produced in connection with dredging and water purification can be removed from the lake via the same suction tube, a so-called “single-pipe system”.

In the system of the invention, a dredging apparatus is used for cleaning the bottom of a lake to remove excessive humus and undesirable fine-grained sediment, which have been partly produced from waste water emissions in the course of decades. Reducing the amount of nutrients dissolved in the water contributes towards improving the natural oxygen situation in the water and promoting the well-being of the biological population.

The cleaning is implemented by utilizing an environmentally friendly and energy-economical dredging apparatus, by means of which the sludge is conveyed via a feeble-constructed plastic discharge pipe into a sedimentation basin. The water separated is finally filtered and passed via an open drain into a natural ditch.

The dredging apparatus is very energy-economical and almost completely nonpolluting as compared with current methods. A further advantage of the system can be seen in the fact that the lake side remains intact as the system does not disturb or damage the environment because the dredgings are passed into a sedimentation basin located at a distance from the lake side area. The cleaning of a lake can be performed even including the shallow coastal waters and grassy areas. Neither do depth variations in the water area impede the use of the equipment. The sedimentation basin is built in a chosen location by making use of natural banks so that no actual construction materials are needed, and the land area in question can be restored after use to its original form.

After final filtering, the water separated from the sedimentation basin is passed in a purified state into the inflow ditch. The humus and sludge carried into the sedimentation basin are composted within the basin area and dried and processed further, to be reused as fertilizer and soil conditioner.

The details of the features characteristic of the method and apparatus of the invention are presented in the claims below.

By applying the invention, a very environmentally friendly and reliable system for use as a cleaning apparatus in a water area is achieved. The dredging of the material to be actually dredged is performed without mechanical loading and transportation.

In the following, the invention will be described in greater detail by the aid of an example with reference to the attached drawings, wherein

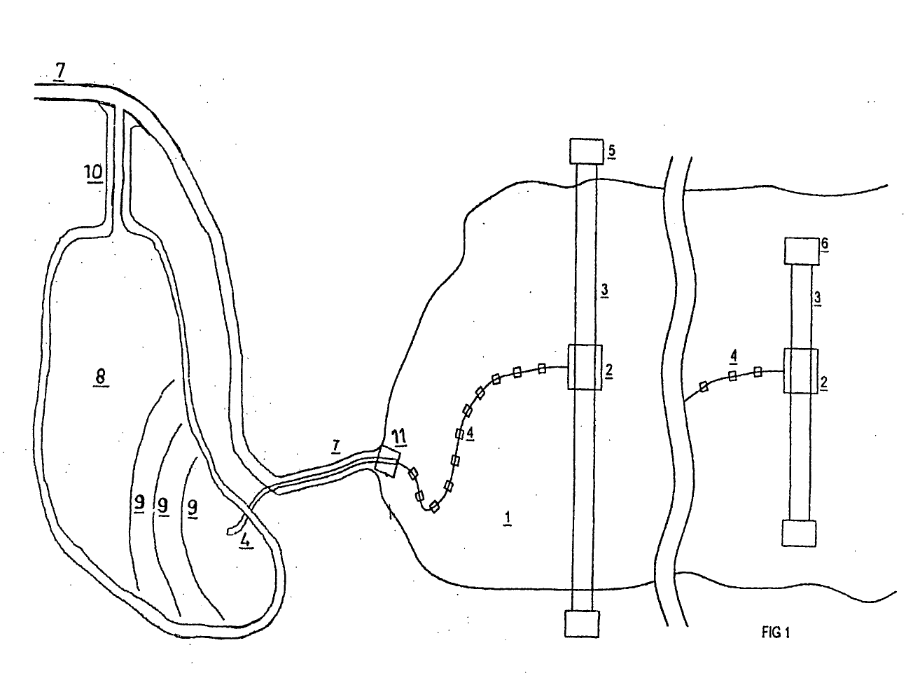

FIG. 1 presents dredging equipment according to the invention, moving on a lake,

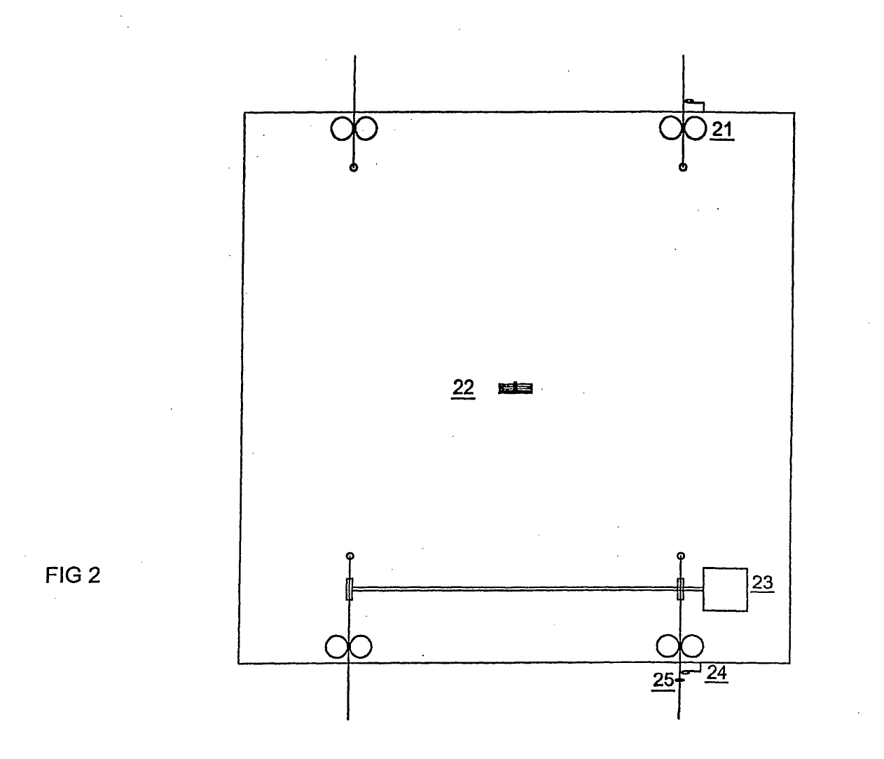

FIG. 2 presents the floating operating carriage of a dredging apparatus,

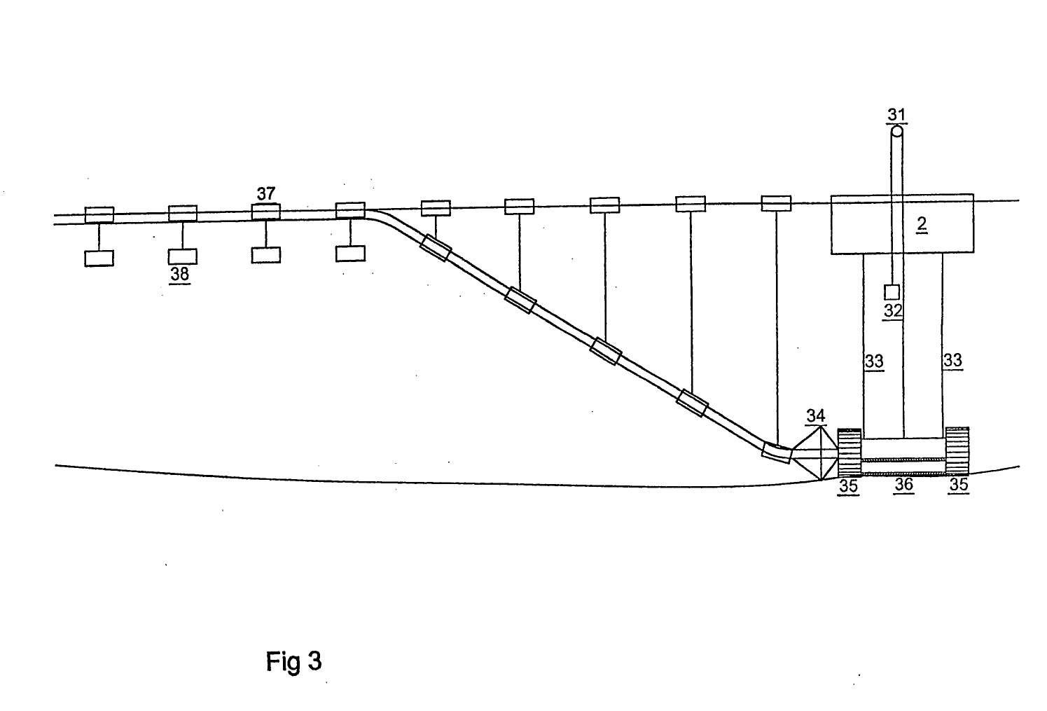

FIG. 3 presents a side view of the dredging apparatus of the invention,

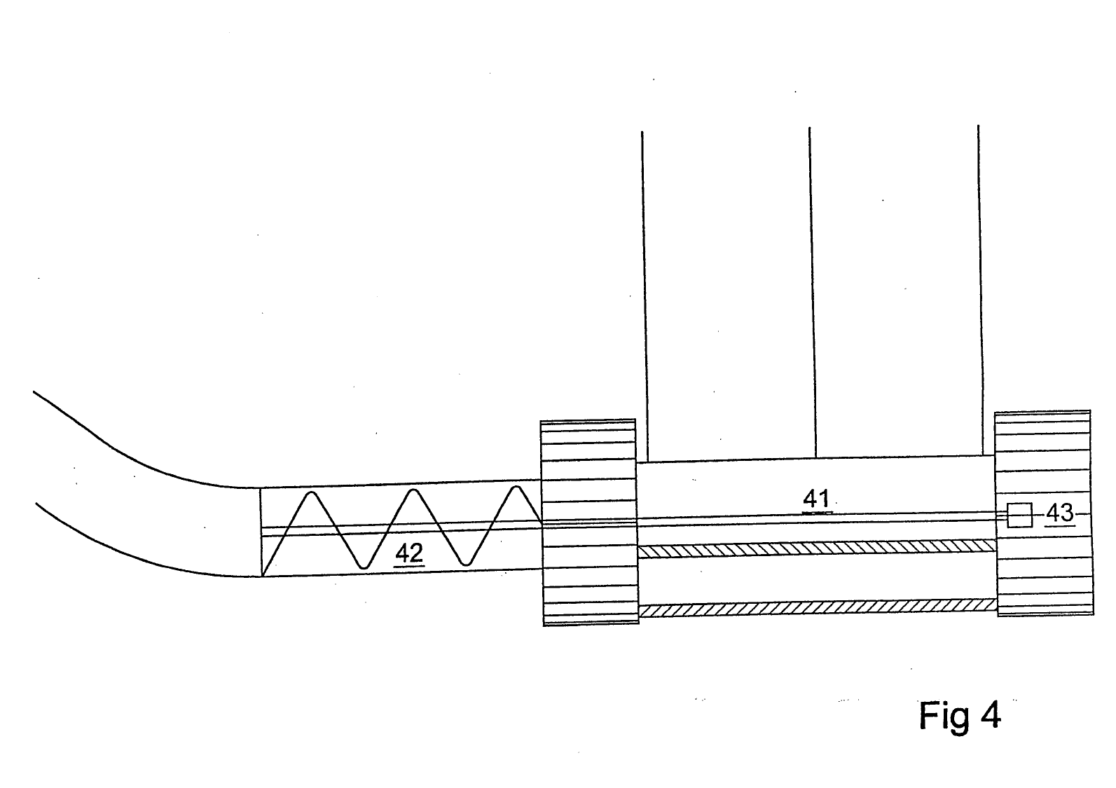

FIG. 4 presents a suction turbine at the end of a suction pipe, and

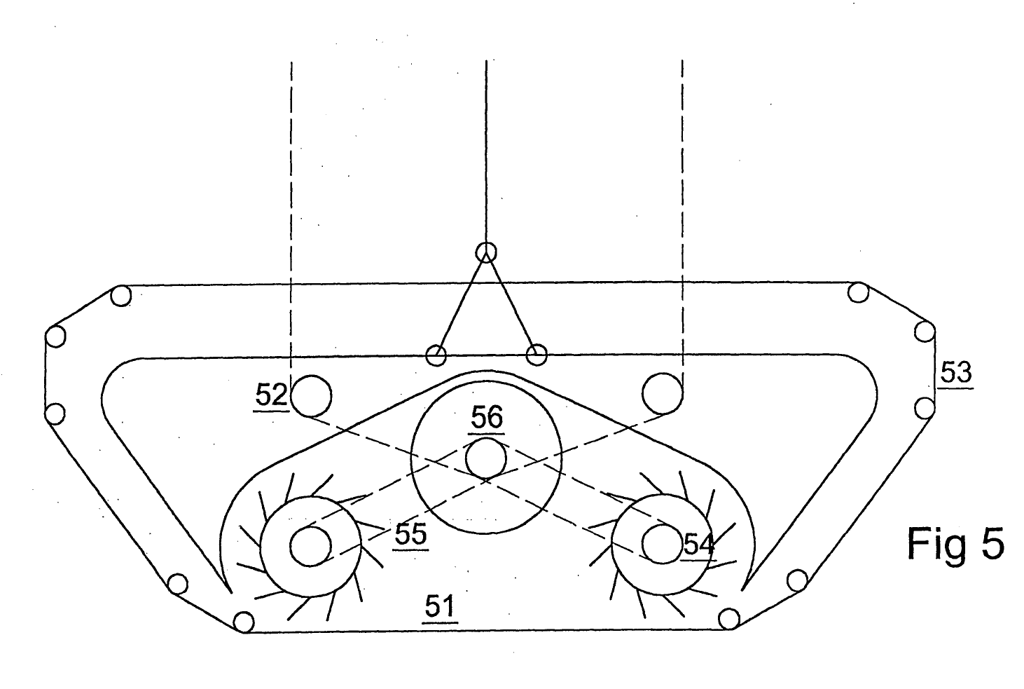

FIG. 5 presents a more detailed view of the dredging apparatus, and

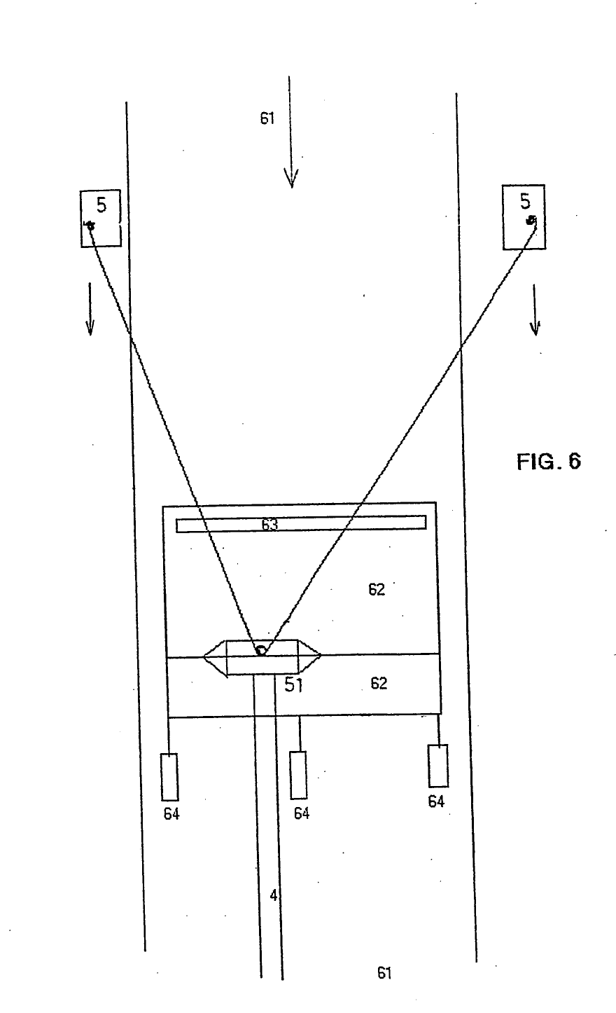

FIG. 6 presents another dredging apparatus according to the invention, moving on a river.

### EXAMPLE 1

FIG. 1 shows dredging systems according to the invention for dredging a lake 1, which comprise a floating operating carriage 2 serving as a kind of ferry supporting the dredging apparatus, guide cables 3 for guiding it, a suction pipe 4 leading to an inflow ditch 7 of the lake or by some other route to a sedimentation area situated at a lower altitude, and coastal vessels 5 or control ferries 6, by means of which the motion of the operating carriage is controlled.

According to the invention, the suction pipe 4 leads into the sedimentation basin 8 located at a lower level. The invention is used to remove the light nutrient organic layer of nutrients and humus from the area of the lake system. By means of the apparatus, light nutrient humus is taken away from the water area (lake) via the piping system 4 into the sedimentation basin 8 located at a lower level and clarified there by reducing the flow rate so that the flow in the discharge area of the pipe 4 in the sedimentation basin 8 is spread over an area (typically 10-50 times) wider than the suction area at the beginning of the pipe. In addition, the flow can be controlled by means of boom elements 9 provided in the basin 8. The mass removed from the lake by suction is deposited, restoring its original form, and the purified water is passed via an exit ditch 10 back into the inflow ditch 7. The end of the discharge pipe 4 is placed below the water surface in the mudflow basin or choked so that no air can enter into the pipe.

Some or all of the operating energy needed in the process is obtained from a suction turbine which is connected between the upper end of the suction pipe and the dredging apparatus and which utilizes the water flow occurring by siphonage in the suction pipe 4 and the movement of the mass mixed in it. It is also possible to use an external energy source.

The floating operating carriage presented in FIG. 2 comprises cable guides 21, counterweight supporting cables 22 and a water hydraulic motor 23 for cable drive. In addition, it may be provided with a reversing switch 24 for the water hydraulic motor and a control stopper 25 attached to the cable.

As shown in FIG. 3, the dredging apparatus comprises a supporting/lightening backstay wire rope 31 connected to a floating supporting/operating carriage and provided with a counterweight 32, as well as operating wire cables 33 for steering right and left. The dredging apparatus moves along the bottom, and it comprises a suction turbine 34, propulsion rollers 35 fitted on a frame and milling/feed rollers 36. The suction pipe is supported by supporting floats 37, and additionally stabilizing weights 38 are provided.

The suction turbine 34 has a main drive shaft 41 and a turbine blade part 42, both connected to the end of the suction pipe. Connected after the turbine is a water hydraulic pump 43 for operating the propulsion rollers and transfer cable etc.

As shown in FIG. 5, the actual dredging apparatus consists of a frame 51, guide rollers 52 for the drive cable, a caterpillar drive roller 53, and milling feed rollers 54 (front and rear) driven e.g. by means of a cogged rubber belt 55 by a main shaft 56. Fitted in the frame are also the end of the suction pipe and the suction turbine. The suction inlet is provided with a limiter. The apparatus is inclined about the main shaft in the direction of motion through about 10-30° relative to the driving roller, so that the forward roller is milling while the rearward roller has a finishing function. The tilting is performed by the water hydraulic cylinders at the same time when the driving direction is changed. The direction of rotation of the feed rollers is not changed when the driving direction changes; instead, it remains the same regardless of the driving direction, only the inclination and the direction of the caterpillar drive are changed. The sludge is removed via the suction pipe.

The operating carriage may also be controlled electrically by means of an electronics unit, which may additionally be provided with e.g. a GPS positioning system for locating the operating carriage and directing it to the right direction of travel. The electric energy needed by the electronics etc. is produced by a water hydraulic generator included in the system. The apparatus can work even at a temperature below 0° C. when it is working under water, in which case it may be operated for long times, possibly round the year, e.g. under remote control or according to a predetermined program for a desired length of time, even under ice. The apparatus works independently of the depth of the lake and, being guided in vertical and horizontal directions by guide cables, it can pass over/under obstacles that can not be avoided using above-water guide equipment.

An extension can be connected to the discharge pipe during operation by using an extension float 11, the pipes and the joint are under water and the flow continues without interruption.

### EXAMPLE 2

FIG. 6 illustrates the operation of the apparatus in the case of cleaning a flowing river 61 in the direction of flow (as seen from the bottom of the river). In this case, the apparatus is used with a protective apron 62 fitted on it to protect the dredging area from the current of the river during the work. The apron may consist of two parts, in which case the dredging apparatus opens and closes the two halves in a zipper-like fashion as it is moving in the transverse direction of the river. Placed on the upper edge of the apron are additional weights 63 pressing the apron against the bottom to prevent excessive funneling of water under the protective apron, thus minimizing undesirable by-pass flow of water in the dredging area. Placed at the lower edge are supporting elements 64, with the help of which the apron can move on when necessary without getting stuck on the bottom during work.

It is obvious to the person skilled in the art that different embodiments of the invention are not limited to the examples described above, but that they may be varied within the scope of the claims presented below.

1. Method for cleaning a water area, such as a lake, pond, river or a similar water basin, characterized in that the water basin is provided with a suction pipe system (4) arranged in connection with the lake (1), pond or equivalent and connected to a dredging apparatus working under water,
by means of which apparatus the sludge or similar waste produced or at least part of it is passed into a suction pipe (4) and through it further into a sedimentation basin (8), where the flow is retarded so that, as it advances through the basin, extra humus and sludge material is separated from it via sedimentation, and that the water thus purified is passed back into the water area, e.g. into an inflow ditch.

2. Method according to claim 1, characterized in that a liquid flow is generated in said pipe by siphonage occurring in consequence of variations of the height level of the pipe, and that, by using a flow converter, such as a suction turbine (34), connected to the suction pipe system, the energy of the flow in the suction pipe is converted into driving energy for the water basin treatment apparatus.

3. Apparatus for cleaning a water area, such as a lake, pond, river or a similar water basin, characterized in that
it comprises a suction pipe system (4) arranged in the water basin in connection with the lake (1), pond or equivalent and connected to a dredging apparatus working under water, by means of which the sludge or similar waste produced or at least part of it is passed into a suction pipe (4) and through it further into a sedimentation basin, said sedimentation basin (8) being provided with a system that retards the flow so that, as it advances through the basin, extra humus and sludge material is separated from it via sedimentation, and that the water thus purified is passed back into the water area, e.g. into an inflow ditch.

4. Apparatus according to claim 3, characterized in that a liquid flow is generated in said pipe by siphonage occurring in consequence of variations of the height level of the pipe, and that the apparatus comprises a flow converter, such as a suction turbine (34), which is connected to the suction pipe system and by means of which the energy of the flow in the suction pipe is converted into driving energy for the water basin treatment apparatus.

5. Apparatus for water purification according to claim 3, characterized in that it comprises a propulsion system provided with wheels, rollers (35) or equivalent for moving it, arranged in connection with the input end of the suction pipe, said propulsion system comprising a coupling device for transmitting the motion of the rotating flow converter to the apparatus.

6. Apparatus for water purification according to claim 3, characterized in that it comprises dredging or cleaning elements (54), which are preferably rotating, and that the apparatus has been equipped to move under water along the bottom of the water basin.

7. Apparatus for water purification according to claim 3, characterized in that it comprises a floating operating carriage (2), on which the dredging or cleaning apparatus is suspended by means of wire cables or the like, so that the load applied by the dredging apparatus to the bottom of the water basin can be accurately limited and kept constant, said carriage being moved by means of a drive mechanism.

8. Apparatus for water purification according to claim 7, characterized in that the drive mechanism comprises control devices (5, 6) controlling the carriage from the shore or its vicinity.

9. Apparatus for water purification according to claim 7, characterized in that the drive mechanism comprises an electronic control unit provided with a positioning system.

10. Apparatus according to claim 3, characterized in that it comprises elements for setting water into motion, such as water circulating equipment, e.g. for producing waves or keeping an area in the water basin in liquid state.

11. Apparatus according to claim 3, characterized in that it is provided with apron means to prevent sludge from being mixed with the main flow or getting elsewhere in the surrounding area, said apron means comprising weights used to prevent excessive funneling of water under the apron means, and suspension means for suspending it.

12. Apparatus according to claim 3, characterized in that the sedimentation basin is provided with a boom system for guiding and dispersing/dividing the flow.

13. Apparatus according to claim 3, characterized in that, to retard the flow, the sedimentation basin (8) has a width substantially larger than the diameter of the pipe (4).

14. Apparatus according to claim 3, characterized in that the dredged mass is conveyed by hydraulic means without mechanical loading and transportation, regardless of distance.
